(19) United States
(12) Patent Application Publication
(10) Pub. No.: US 2002/0129066 A1
(43) Pub. Date: Sep. 12, 2002

(54) Computer implemented method for reformatting logically complex clauses in an electronic text-based document

(76) Inventors: David R. Milward, Cambridge (GB); Robert G. Corbin, Chippenham (GB); Stephen G. Pulman, Thriplow (GB)

Correspondence Address: David L. McCombs, Haynes and Boone, LLP, Suite 3100, 901 Main Street, Dallas, TX, 75202, US

(21) Appl. No.: 09/752,845

(22) Filed: Dec. 28, 2000

(51) Int. Cl. G06F 15/00

(52) U.S. Cl. 707/523

(57) ABSTRACT

A method of reformatting logically complex clauses, in particular for enabling detection and correction of potential ambiguity in legal documents, is disclosed. The method comprises four distinct stages. Firstly, a passage of text is analysed into its constituent parts of speech. Next, groups of words that belong together in large phrases are concentrated into larger units using linguistic rules. Thirdly, further linguistic patterns take account of the grouping of these concatenated phrases and pick out occurrences of logically important words or phrases that represent conjunctions. The disclosed method uses rules to determine whether the identified conjunctions are top level, i.e. logically significant, or whether they are subordinate, i.e. link smaller phrases in the text. In the final stage, the annotated grammatical and logical formation is used to display the original text in such a way that the logical structure is revealed. The method is suitably computer-implemented through a software routine operable upon text in a word processing package.

### FIELD OF THE INVENTION

This invention relates to a method for reformatting logically complex clauses so as to clarify and to disambiguate them, and to an implementation of such a method by computer.

### BACKGROUND OF THE INVENTION

Many forms of legal or technical documents contain long sentences which make reference to many conditions, alternatives or exclusions. These long and grammatically complex sentences can be difficult to understand, or easy to misunderstand. In the case of such documents, misunderstandings can lead to expensive errors being made. The source of errors lies typically in the fact that these sentences relate several different propositions to each other using logical or causal relations. Because of the length of the sentences, and their syntactic and semantic complexity, it is easy inadvertently to create situations reminiscent of what is known in computer programming language terms as the “dangling else” problem: given a nested conditional of the form:

if P then if Q then R else S

It is impossible to determine whether the “else” condition is associated with the conditional clause “if P . . . ” or the conditional clause “if Q . . . ”. The two situations are of course logically distinct: if the else condition is associated with “if P . . . ” then S will be the case whenever P is not true, regardless of the state of Q and R. However, if the else condition is associated with “if Q . . . ”, then S will only be the case if P is true but Q is not.

In modern electronic documents, word processing programs allow a good, unambiguous style to be adopted with relative ease. A sentence drafter may break up a sentence, using for example bullet points or indentation to separate out the different components and show how they are related. To return to the example above, it may be written as:

if P then

if Q then R

else S

Indicating that the else condition is associated with “if Q . . . ”. By instead formatting the sentence as

if P then

if Q then R

else S

It is visually indicated that the else condition is associated instead with the condition “if P . . . ”. In other words, proper formatting allows the dangling else problem to be resolved visually.

Unfortunately, many drafters do not take advantage of the formatting features available in modern Word processing packages. Often, existing documents (particularly those scanned in from typed versions) are only formatted by paragraph.

Various form of text analysis are built into current Word processing packages. In their most basic form, these allow simple text string matching. Microsoft® Word(™) allows for simple grammatical checking of documents. These do not and cannot, however, analyse lengthy and complex sentences. Various attempts have been made to address whole sentence analysis using full syntactic and semantic analysis, and a brief discussion of this has been provided in the paper by R. Corbin, entitled “Using NLP to check Contract Documentation”, presented at “Natural Language Processing: Extracting Information for Business Needs” and published in the conference proceedings in 1997. To date, the use of full syntactic and semantic analysis has proved to be of limited accuracy and in any case requires significant processing capabilities when implemented on a computer.

### SUMMARY OF THE INVENTION

The present invention provides an improved technique suitable for implementation on a computer which allows rapid analysis and automatic reformatting of a passage of text. According to the present invention, there is provided a method of analysing and reformatting a passage of text, comprising the steps of: (a) identifying words in the passage of text representing different parts of speech; (b) grouping at least some of the identified words into discrete units representing discrete linguistic phrases, so as to generate a partially analysed text passage; (c) identifying logically significant conjunctions within the said partially analysed text passage; and (d) reformatting the passage of text that has been analysed so as to reveal the logical structure thereof.

Identifying logically significant conjunctions after first carrying out a partial, incomplete syntactic and semantic analysis allows automatic reformatting of passages of text (such as complex sentences) in a particularly efficient manner. Searching for patterns in the output of a partial analysis has proved, surprisingly, reasonably robust with respect to inaccurate or incomplete analysis of the “raw” passage of text. The benefits in analysis of lengthy documents such as contracts for example are manifest, allowing complex legal sentences to be displayed in a manner that allows for the detection and correction of potential ambiguity.

This in turn reduces the risk of potentially costly interpretation errors.

The method is preferably implemented as a software routine for use on a personal computer. For example, a passage or passages of word processed text can be exported to the software application, for analysis in accordance with the invention, and then returned to the word processor for display in the reformatted form.

The different parts of speech may be identified from the passage of text to be analysed by use of a statistical technique such as Hidden Markov Modelling. The step of identifying the parts of speech may involve labelling words with a tag indicative of the particular identified part of speech.

Preferably, the method further comprises grouping at least some of the words in the passage into a first set of intermediate phrases on the basis of a predetermined set of linguistic rules. For example, a word identified as a definite article such as “the” may be grouped with a noun (“contractor”) and an adjective (“first”) to generate a noun phrase. Such a phrase may be tagged or labelled as such.

Most preferably, a recursive analysis, still based upon a set of linguistic rules, may be employed to conjoin the first phrases into a second set of final phrases. For example, noun phrases may be combined with prepositional phrases to generate larger phrases. The recursive analysis may be carried out by repeatedly applying a finite state analysis until, in accordance with the linguistic rules, no further “phrase building” is possible.

Preferably, the step of identifying conjunctions comprises searching for predetermined patterns of phrases from the second set of final phrases constituting the partially analysed text passage.

In a particularly preferred embodiment, the method further comprises after the said step of identifying logically significant conjunctions in the partially analysed text passage, the steps of identifying a grammatically appropriate location for inserting of a second part of a two part conjunction within the passage of text to be analysed, when such second part of the said conjunction is not already present; and automatically inserting at the identified location, an indicator into the reformatted passage of text when the text is displayed, the said indicator indicating that the said second part of the conjunction should be present there.

There are many forms of two part conjunction, such as “If . . . , then . . . ”; “Both . . . , and . . . ” and so forth. The second part (usually a word such as ‘then’, but also potentially just a comma) is sometimes omitted from the original text to be analysed. Inserting an indicator such as an arrow, can thus be helpful in improving clarity and reducing ambiguity.

The invention also extends to a computer program having a plurality of program elements, the program, when executed on a personal computer, being arranged to carry out the method set out above. In that case, the program may be arranged to receive the passage of text in either unformatted ASCII form, or partially formatted (that is, still containing information necessary for a word processing program to reformat the text in accordance with the invention) prior to analysis, and further arranged to output the reformatted passage of text also in either unformatted ASCII or, more suitably, as partially formatted text, after analysis, for receipt by a word processing program.

In yet a further aspect of the invention, there is provided a computer readable medium upon which is recorded the aforementioned program.

### BRIEF DESCRIPTION OF THE DRAWINGS

The invention may be put into practice in a number of ways, one of which will now be described by way of example only and with reference to the accompanying drawings, in which:

FIG. 1 is a schematic diagram of a personal computer having a screen displaying text both before and after application of the method of the invention;

FIG. 2 is a highly schematic diagram of a part of the architecture of the personal computer of FIG.

FIG. 3 is a flow diagram of the first stage in the processing of electronic text according to the invention;

FIG. 4 is a flow diagram of the second stage of the processing of electronic text according to the invention; and

FIG. 5 is a flow diagram of the third stage in the processing of electronic text according to the invention.

### DETAILED DESCRIPTION OF THE PREFERRED EMBODIMENT

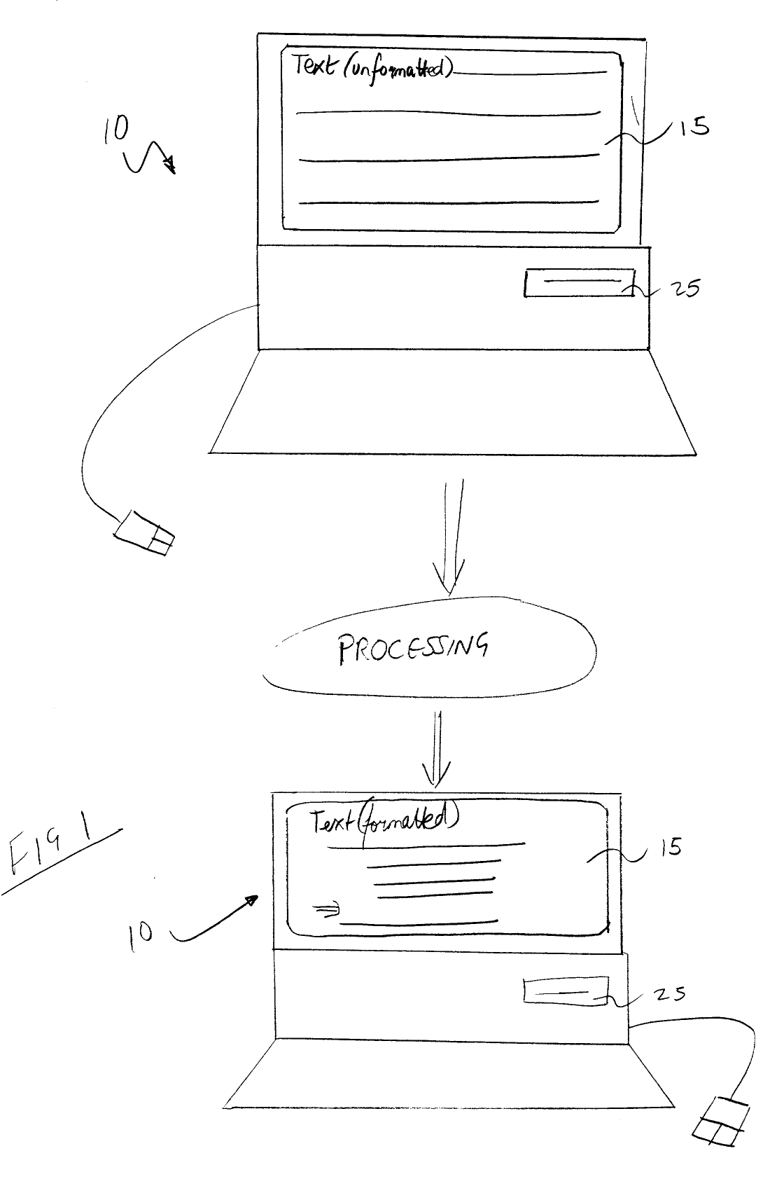

The technique of the invention is preferably implemented as a computer sub-routine for operation on, for example, a personal computer 10. A suitable arrangement is shown in FIG. 1. Text to be reformatted is initially displayed upon a screen 15 of the personal computer 10, in a form defined by the parameters of a word processing package such as Microsoft® Word(™). This format, although containing formatting information from the word processor itself, contains natural fine breaks and so forth and is not set out in a manner which might reveal the logical structure of the text.

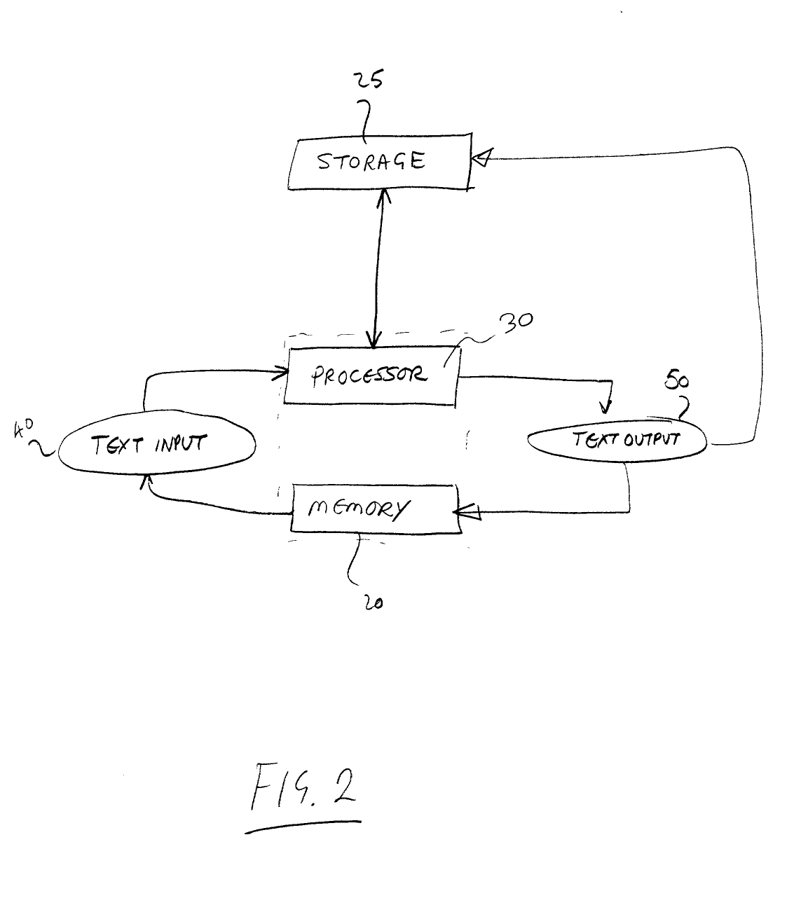

The algorithm of the invention is preferably called as a sub-routine from the word processing package. Typically this will reside in a memory 20 of the personal computer obtained from a storage device 25 such as a disk drive (FIG. 2) and program steps will be executed under the control of a processor 30.

In a particularly preferred embodiment, the sub-routine is written using the Prolog language which will be well known to those of ordinary skill. The sub-routine is called from within Word(™) by a Microsoft® Visual Basic(™) Script and will likewise reside in memory 20.

The Prolog program first receives a copy 40 of the text to be reformatted from the word processing package. This is achieved either by highlighting a section of text in the word processing package to be reformatted, or by selecting a menu option within the word processing program to reformat the entire document currently open in that word processing program. In this manner, a full document may be analysed, or just a single sentence.

In brief, the Prolog sub-routine takes the copy 40 of the text from the Word(™) word processing program, carries out the stages of analysis outlined below, and produces an output file 50 in which the text and the formatting information (introduced as a result of the linguistic analysis) is also represented in a form capable of being displayed and edited within Word(™) as is shown in FIGS. 1 and 2. Typically this involves the generation of an output formatting instruction set.

The resultant text output may be sent for display by the screen 15 of the personal computer 10 (see FIG. 1) and/or may be stored in storage device 25 (FIG. 2).

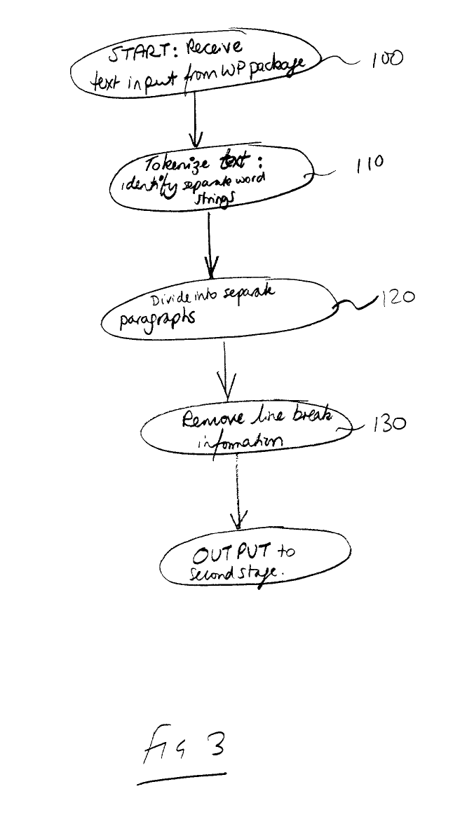

The procedure will now be described in more detail, referring to the flow charts of FIGS. 3-5.

Tokenising

The first step is for the Prolog sub-routine to “tokenise” the text received from the Word(™) word processing program. This turns the Word file (or a stripped-down version thereof) into a file in a format containing Prolog terms representing sentences. All information is preserved at this stage. The tokeniser routine is configurable so as to treat various special characters as required, to recognize abbreviations, and so forth.

As an example, a typical text file as received by the Prolog sub-routine at step 100 of FIG. 3 may be:

Example 1, raw text

If the Contractor shall neglect to execute the Works with due diligence and expedition, or shall refuse or neglect to comply with any reasonable orders given to him in writing by the Engineer in connection with the Works, or shall contravene the provisions of the Contract, the first aforementioned purchaser may give seven days' notice in writing to the Contractor to make good the failure, neglect or contravention complained of.

At step 110, the Prolog tokeniser turns this into a file which looks like:

Example 1, tokenised text

sentence ([′If′, the, ′Contractor′, shall, neglect, to, execute, the, ′Works′, with, due, diligence, and, expedition, ′,′, or, shall, refuse,or, neglect, to, comply, with, any, reasonable, orders, given, him, in, writing, by, the, ′Engineer′, in, connection, with, the, ′Works′, ′,′, or, shall, contravene, the, provisions, of, the, ′Contract′, ′,′, the, ′Purchaser′, may, give, seven, days, ′′′′, notice, in, writing, to, the, ′Contractor′, to, make, good, the, failure, ′,′, neglect, ′,′, or, contravention, complained, or, ′,′]).

The Prolog sub-routine next splits the received text into paragraphs (step 120) and then removes line break information (step 130). The resulting tokenised file is used for the second stage of the process.

Tagging

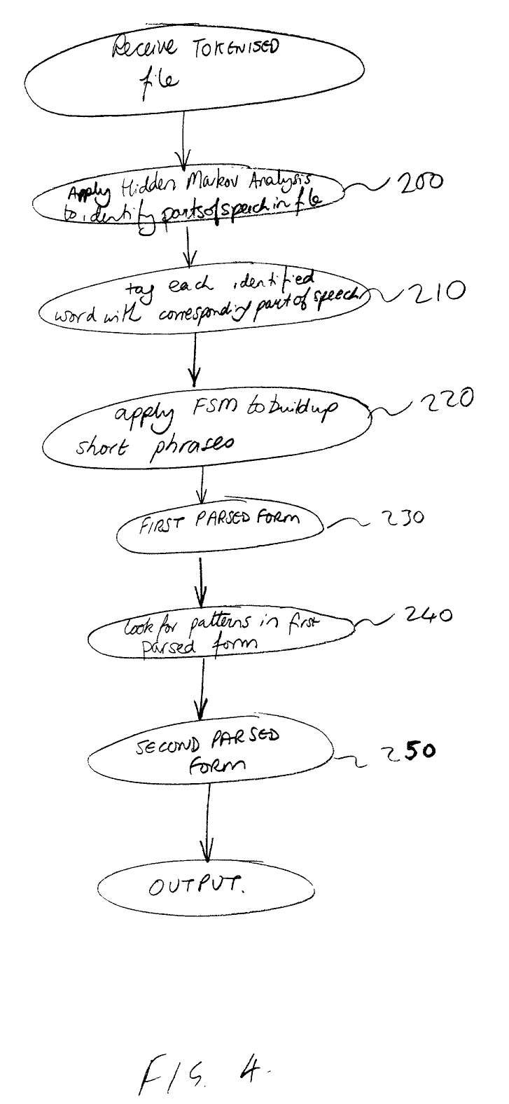

The next task carried out by the Prolog sub-routine is to analyse the passage (in this example, a sentence) into its most likely sequence of “parts of speech”, and this is shown at step 200 in FIG. 4. That is, each word in the sentence is analysed to determine which grammatical label (“noun”, “verb”, “adjective” etc.) is most appropriate. Once the program has decided on the most appropriate grammatical label for a particular word, it is labelled with a tag (step 210).

In the preferred embodiment, a statistical technique known as Hidden Markov Modelling is employed to make this decision. The technique uses a corpus of sentences in which each word has been annotated with the correct part of speech, in order to train a statistical model of the likelihood that one part of speech will be found following another. The purpose of a statistical analysis is to attempt to remove ambiguities when words are spelled identically but have different meanings or indeed different grammatical senses, depending upon the contexts. For example, the word “associates” can be either a plural noun, as in “the company's associates”, or a third person singular verb, as in “we know he associates”. The statistical analysis can determine the most likely grammatical label from the context. In some cases, as with, for example, “the company associates with”, there may be no clear statistical difference between the two possibilities (plural noun or singular third person verb), and in this case the choice made by the program is determined on the basis of which annotation within the training corpus is encountered the most frequently overall.

The principles of statistical analysis such as Hidden Markov Modelling are further described in, for example, James Allen, “Natural Language Understanding” 2nd edition, Benjamin/Cummings Publishing Co. Inc., 1995, between pages 195 and 204.

The passage of text, analysed according to its parts of speech, and tagged, will then appear as follows:

Example 1, tagged form

(′If′/in, the/dt, ′Contractor′/nn, shall/md, neglect/vb. to/to, executr/vb, the/dt, ′Works′/nns, with/in, due/jj, diligence/nn, and/cc, expedition/nn, ′,′/′,′, or/cc, shall/md, refuse/vb, or/cc, neglect/vb, to/to, comply/vb, with/in, any/dt, reasonable/jj, orders/nns, given/vbn, him/prp, in/in, writing/nn, by/in, the/dt, ′Engineer′/nn, in/in, connection/nn, with/in, the/dt, ′Works′/nns, ′,′/′,′, or/cc, shall/md, contravene/vb, the/dt, provision/nns, or/in, the/dt, ′Contract′/nn, ′,′/′,′, the/dt, ′Purchaser′/nn, may/md, give/vb, seven/cd, days/nns, ′′′′/′′′′, notice/nn, in/in, writing/nn, to/to, the/dt, ′Contractor′/nn, to/to, make/vb, good/jj, the/dt, failure/nn, ′,′/′,′, neglect/nn, ′,′/′,′, or/cc, contravention/nn, complained/vbn, of/in, ′.′/′.′]

Where: /in is a tag indicating a preposition or subordinate conjunction; /dt is a tag indicating a determiner word (“the” or “a”, for example); /nn indicates a singular noun' /md indicates a modal verb; /vb indicates a verb; /to indicates an infinitive marker for a verb; /nns is a plural noun; /jj indicates an adjective; /cc is a coordinating conjunction; /vbn is a past participle; /prp is a personal pronoun; and /cd is a cardinal number.

It will be understood that the results of the tagging analysis will depend upon the training corpus (i.e. the statistical basis) employed.

Phrasal Analysis

The next stage carried out by the Prolog sub-routine is to group words that belong together, grammatically, into larger phrases and then label these larger phrases appropriately. This is carried out using linguistic rules. The aim is to try to build phrases ‘bottom up’ until as many words as possible have been incorporated into phrases. Then any remaining logical words (‘and’, ‘or’, ‘if’, etc.) will probably be associated with the high level logical structure of the sentence, and can be recognised as such by the next stage of analysis (see below). Notice that the tagging process cannot distinguish between different uses of words like ‘and’ and ‘or’: it is only able to say that they are conjunctions, since the tagging process only looks at words in the context of the preceding one or two words. This process will now be described in detail, referring to FIG. 4 once more.

Phrases are recognised both by finite state machines (FSMs), and also by patterns. Examples of finite state machines for recognising Noun Phrases and Verb Groups (represented as regular expressions which are compiled to FSMs for actual processing) are:

[(dt;pps;cd), (nn;nns),nn].

This expression says that a Noun Phrase may optionally begin with a determiner (the, a, etc.), or a possessive pronoun (his, her, . . . ), or a number (2, three, . . . ), optionally followed by either a singular or a plural noun, ending with a singular noun. Some of the Noun phrases recognised by this expression include: ‘the plan; his work plan; three stage plan’, etc.

[md,?(rb),vb,vbg].

This expression says that a Verb Group may consist of a modal auxiliary (can, may etc.) optionally followed by an adverb, followed by a verb in the infinitive form, followed by a verb in the -ing form: e.g. ‘ . . . may(soon)be completing . . . ’. This step is shown in FIG. 4 at 220.

An example of a pattern is:

[NP1/np,of/in,NP2/np]==>[[NP1/np,of/in,NP2/np]/np]

Where [NP1/np,of/in,NP2/np] is the input and [[NP1/np,of/in,NP2/np]/np] is the output.

This pattern says that when a sequence of two Noun Phrases separated by an ‘of’ is present, these are to be grouped together as a single Noun Phrase, as in ‘[[the operator] of [the machinery]]’. There are similar patterns for recognising complex Verb Groups, Prepositional Phrases, conjunctions of various types of phrase, and so forth. This step is shown at 240 in FIG. 4.

The patterns and finite state machines are applied in a predetermined sequence which is typically determined using trial and error. Firstly, finite state machines are applied to look for a few idioms, simple conjunctions, and noun and verb groups (steps 220 and 230):

Example 1, Low level parsed form

[the/dt, ‘Contractor’/nn]/np, [shall/md, neglect/vb9 /vg, [to/to, execute/vb]/vg, [the/dt, ‘Works’/nns]np, with/in, [due/jj, [diligence/nn, and/cc, expedition/nn]/nn]/np, ′,′,/′/′, or/cc, [shall/md, [refuse/vb, or/cc, neglect/vb]/vb]/vg, [to/to, comply/vbj/vg, with/in, [any/dt, reasonable/jj, orders/nns]/np, [given/vbn]/vg, [him/prp]np, in/in, [writing/nn]/np, by/in, [the/dt, ‘Engineer’/nn]np, in/in, [connection/nn:/np, with/in, [the/dt, ‘Works’/nns]/nns]/np, ′,′/′,′, or/cc, [shall/md, contravene/vb]/vg, [the/dt, provisions/nns]np, of/in, [the/dt, ‘Contract’/nn]/np, ′,′/′,′, [the/dt, ‘Purchaser’/nn]/np, [may/md, give/vb]/vg, [seven/cd, days/nns]/np, ′′′′/′′′′, [notice/nn]np, in/in, [writing/nn]/np, to/to, [the/dt, ‘Contractor’/nn]np, [to/to, made/vb, good/jj]/vg, [the/dt, [failur/nn, ′,′/′,′, neglect/nn, ′,′/′,′, or/cc, contravention/nn]/nn]/nn]/np, [complained/vbn]/vg, or/in, ′.′/′.′]

Next, the Prolog sub-routine searches for higher level patterns (step 240). Groups of patterns can also be applied in a specified order. The final result with the current preferred configuration of patterns will be (step 250):

Example 1, higher level parsed form

[‘If’/in, [the/dt, ‘Contractor’/nn]/np,

[[bdhall/md, neglect/vb]/vg, [to/to, execute/vb]/vg, [the/dt, ‘Works’/nns]/np,

[with/in, [sue/jj, [diligence/nn, and/cc, expedition/nn]n/np]/pp, ′,′/′,′, or/cc,

[[shall/md, [refuse/vb, or/cc, neglect/vb]/vb, [to/to, comply/vb]/vg]/vg,

[with/in, [any/dt, reasonable/jj, orders/nns]/nnl/pp,

given/vbn]/vg, [him/prp]/np, [in/in, [writing/nn]/np]/pp,

[by/in, [the/dt, ‘Engineer’/nn]/np]/pp,

[in/in, [connection/nn]/np]/pp, [with/in, [the/dt, ‘Works’/nns]mnp]/pp, ′,′/′,′, or/cc, [shall/md, contravene/vb]/vg,

[[the/dt, provisions/nns]n/np, of/in, [the/dt, ‘Contract’/nn]/np]/np, ′,′/′,′, [the/dt, ‘Purchaser’/nn]/np, [may/md, give/vb]/vg,

[[seven/cd, days/nns]/np, ′′′′/′′′′m [notice/nn]/np]/np,

[in/in, [writing/nn]/np]/pp, [to/to, [the/dt, ‘Contractor’/nn]/np]/pp,

[to/to, make/vb, good/jj]/vg, [the/dt, [failure/nn, ′,′/′,′, neglect/nn, ′,′/′,′, ot/cc, contravention/nn]/nn]/np, [complained/vbn]/vg, of/in, ′.′/′.′],

Identification of Logically Significant Conjunctions

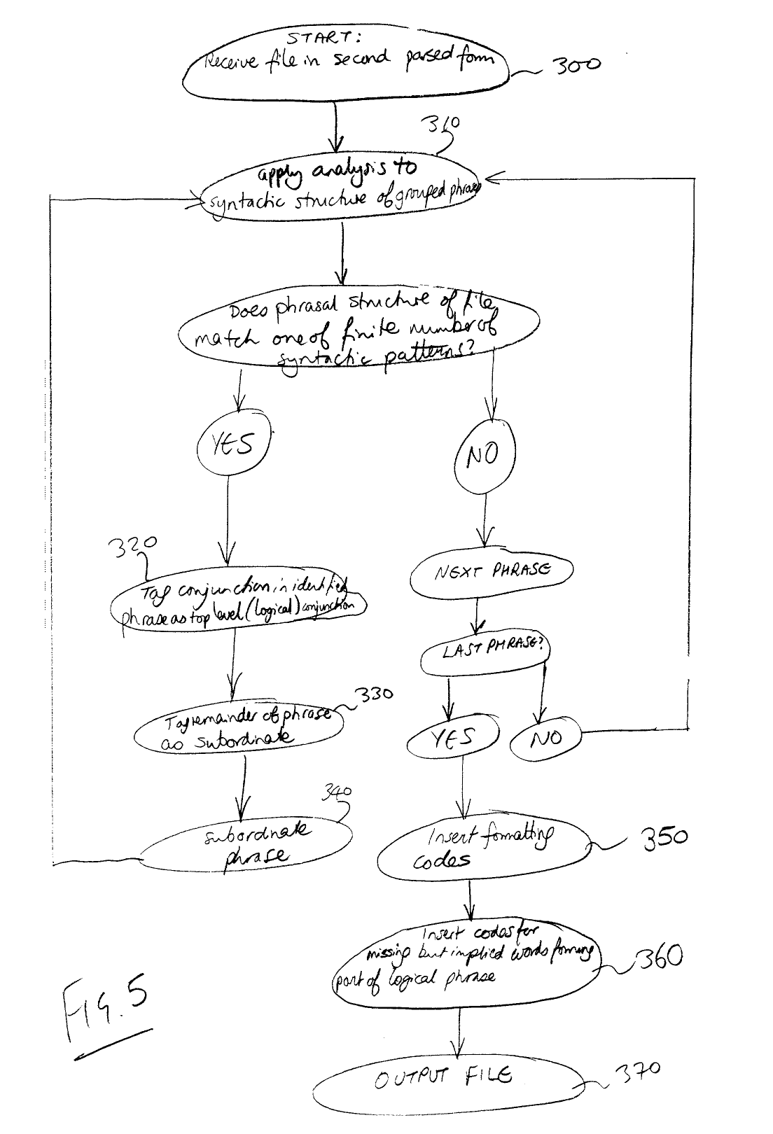

The penultimate stage in the process carried out by the program is to look for linguistic patterns taking account of the grouping of the larger level phrases. This is illustrated with reference to FIG. 5. The purpose of this is to pick out occurrences of logically important words or phrases constituting a conjunction or a conjunction phrase. Words like “if ”, “and”, “although”, “in the event of” and so forth are examples of conjunctions or conjunction phrases. The purpose of looking for certain patterns is to identify whether the conjunctions are “top level”, indicating that they refer to logical relationships between clauses in a sentence, or whether they are instead “subordinate”, meaning that they do not signal major logical relations between clausal level units but rather between smaller phrases or units. Again with reference to the example, the conjunction “or” in the phrase “shall refuse or neglect” is subordinate. The conjunction “or” between the phrase “shall refuse or neglect to comply with any reasonable orders given him in writing by the Engineer in connection with the Works”, and the phrase “shall contravene provisions of the Contract . . . ” is a logically significant conjunction.

The analysis carried out in the Phrasal Analysis stage outlined above will identify some, but not necessarily all, of the subordinate conjunctions. The resulting higher level parsed file is employed as shown at step 300 in FIG. 5. The penultimate stage of the analysis carries out tests on the syntactic structure of the sentence in which they are found (step 310). For example, a pattern such as:

If . . . verb group . . . , noun phrase verb group . . . ”

May be sought. If a sentence is found matching such a pattern, the “if” will be annotated or tagged as a top level conjunction (step 320); the material between the “if” and the “comma” will be annotated as subordinate (step 330), and patterns will be applied to this material to discover any nested structure (step 340). This is because there may, in fact, be top level, logically significant conjunctions within the condition. The position after the comma will be treated as a possible position for a “then”, which would be logically associated with the “if”. In practice, rather than there being a specific pattern for “if”, patterns are generalised to apply to conjunctions sharing certain properties. There are about 30 generalised patterns which cover over 50 different conjunctions. These recognize the most common configurations of grammatical structure found in legal and technical documents.

As an illustration of these principles, reference is again made to the text in Example 1. In the higher level parsed form, this text matches the following pattern:

| | | |
|---|---|---|
| 1 | sub_conj :sp: | [SubCoord/T1,n:A1,NP/np,VG2/Vg]: |

| | |
|---|---|
| 2 | (pre_conjunction(Sub_Coord), |
| 3 | set_conj_feat(level,T1,T1a,top), |
| 4 | member)_VG/vg,A1), |
| 5 | test_for_active_vg(VG2/Vg), |
| 6 | last_word(A1,′,′/′,′), |
| 7 | process_conj_structure(A1,A2)) |

| | |
|---|---|
| 8 | ==> |
| 9 | [SubCoord/T1a, [n:A2]/sua(r),NP/np,VG2/Vg]. |

This may paraphrased line by line. A verbal explanation is:

1. a subordinating conjunction pattern, triggered by a constituent SubCoord, labelled T1, followed by any number of items assembled into a sequence A1, followed by a noun phrase Np labelled np, followed by a verb group phrase VG2 labelled Vg. This is one of a finite number of primary patterns sought. However, to avoid false identification, various checks or tests are then carried out:

2. SubCoord must be a ‘pre_conjunction’: a word like ‘if’, or a phrase like ‘in the event that’.

3. The value of the level feature in the label T1 on this conjunction is set to ‘top’: this label is now T1a.

4. The sequence A1 must contain a verb group.

5. The final verb group VG2 must pass a test that it is active (i.e. not a passive: “(be)VERBed by”).

6. The last word of the sequence A1 must be a comma.

7. This process is called recursively on the sequence A1 to find any further instances within it, with result A2.

8. The output is:

9. The SubCoord constituent, with label T1a, followed by the sequence A2, labelled “sua(r)” to indicate that it should be followed by a ‘then’ or an arrow to make its meaning clear, followed by the NP and VG2 constituents. There are about 30 such patterns in the current implementation, covering the most frequently preferred encountered types of construction in the target documents. These (including the pattern used as an example above) are set out in Appendix I. The text between asterisks indicates a comment or remark. Obviously, more patterns could be employed but it is a feature of the invention that preferred embodiments strike a balance between accuracy and speed of processing. This is optimised with the two-part analysis (statistical modelling followed by larger pattern searching) that forms the core of the analysis and it is clearly undesirable that the pattern searching requires inordinate amounts of processing. The use of about 30 patterns has been found to achieve accurate linguistic analysis in most situations without sacrificing processor speed.

It will be understood by those of ordinary skill that the foregoing is merely a specific example of a presently preferred embodiment that illustrates the invention in a clear and sufficient manner. It will therefore be appreciated that the number and structure of patterns will in general depend upon the application contemplated. The presently described embodiment relates to the reformatting of a legal contract. For technical documents such as a user manual for a complex item, it may still be desirable to reformat this which should in turn permit a reduction in the potential for misunderstandings. The grammatical constructs may be very different in technical as opposed to legal documents.

The following give an illustration of some of the currently preferred patterns: they may be added to as new adaptations of the software are made. ‘SubCoord’ covers words like ‘if’ and ‘whenever’, and phrases like ‘in the event that’.

SubCoord . . . vg . . . , then . . .

SubCoord . . . vg . . . , np vg

SubCoord . . . vg . . . , either vg

SubCoord . . . vg . . . , pp np vg . . .

SubCoord . . . vg . . . , np pp vg . . .

SubCoord . . . vg . . . , np, pp, vg

SubCoord . . . vg . . . then . . . vg

SubCoord . . . np vg . . . np vg

The next stage of the program is to use the tags applied on the basis of the foregoing grammatical and logical analysis to insert formatting information readable by the word processing package (step 350). For example, the program may insert a line break after the first “if” in the preceding example. The clause subsequent may be indented relative to the preceding conjunction, and the program automatically inserts formatting information readable by the word processing package. At the end of that clause, a line break may be inserted so that the next top level conjunction is on the following line, and this itself may be indented but only partially. If desired, once this formatting information has been inserted, the tags may be stripped out again, but in an alternative embodiment, the tags are left in. Although not usually visible on the screen of the word processing package, they can be revealed if desired.

The example given above could be displayed as follows:

Example 1, displayed format

If

the Contractor shall neglect to execute the Works with due diligence and expedition,

or

shall refuse or neglect to comply with any reasonable orders given him in writing by the Engineer in connection with the Works,

or

shall contravene the provisions of the Contract,

==>

the purchaser may give seven days' notice in writing to the Contractor to make good the failure, neglect or contravention complained of.

It will be appreciated that this is simply one suitable format. The program contains a number of user-customisable options to allow, for example, line breaks to occur only at phrasal boundaries. It has been determined through psychological experiments that such formatting aids understanding. In the standard configuration, however, the annotation is used to lay out the sentence so as to reveal the logical dependencies between the top level clauses.

It will also be noted that an arrow (“==>”) has been inserted and indented as appropriate. The arrow is normally indicative of an implied “then” which could in fact be inserted in lieu of the arrow in this particular example. The program is arranged to insert a general indicator such as ==> whenever a two part conjunction is identified and where the second part of that conjunction is missing (step 360). For example, the conjunction ‘both . . . ’ require a following ‘and . . . ’, ‘either . . . ’ requires ‘or . . . ’, and ‘although . . . ’ simply requires a comma. It would of course be possible to insert the correct ‘second part’ of the conjunction where it is considered to be missing. However, the general purpose arrow inserted at the appropriate place has been found to be adequately indicative of meaning (and thus able to improve comprehensibility) without compromising accuracy.

Once an output file 50 (FIG. 2) has been generated at step 370, this can be displayed on the computer screen as shown in the lower half of FIG. 1.

The technique described above is of particular commercial value wherever long and complex documents need to be used. When drafting or redrafting legal contracts or technical documentation, the reformatter can be used to check that the sense of a sentence is clear, or display the formatted version so as to make absolutely clear what the logical connections between components of the sentence or passage are. For documents that are being read and responded to, such as draft contracts from another party, calls for tender, etc. the technique of the present invention offers a quick way to help understand complex legal or technical sentences. This in turn can save both time and money, in avoiding situations where unrecognized errors would have led either to cost penalties (for example, if some complex condition had been misunderstood), or to future costly re-engineering, if some aspect of a technical requirement or specification had been misconstrued.

It will also be understood that the principles set out are applicable not just to the English language, but to any language capable of statistical and phrasal analysis.

[image]

[image]

[image]

[image]

[image]

[image]

[image]

[image]

[image]

[image]

[image]

[image]

1. A method of analysing and reformatting a passage of text, comprising the steps of:
(a) identifying words in the passage of text representing different parts of speech;
(b) grouping at least some of the identified words into discrete units representing discrete linguistic phrases, so as to generate a partially analysed text passage;
(c) identifying logically significant conjunctions within the said partially analysed text passage; and
(d) reformatting the passage of text that has been analysed so as to reveal the logical structure thereof.

2. The method of claim 1, in which the step of identifying words in the passage of text representing different parts of speech comprises employing a statistical analysis upon the words in the passage of text so as to determine a most likely part of speech category for each word.

3. The method of claim 2, in which the step of performing a statistical analysis comprises performing Hidden Markov Modelling upon the passage of text to be analysed.

4. The method of claim 1, in which the steps of grouping at least some of the identified words into discrete units comprises grouping at least some of the identified words into a first set of intermediate phrases on the basis of a first predetermined finite set of linguistic rules.

5. The method of claim 4, in which the first set of intermediate phrases includes a phrase selected from the list comprising a noun phrase and a verb phrase.

6. The method of claim 4, in which the step of grouping at least some of the identified words into discrete units further comprises grouping at least some of the intermediate phrases into a second set of final phrases on the basis of a second predetermined finite set of linguistic rules, such that a selected one of the final phrases in the said second set is made up of a plurality of intermediate phrases from the said first set.

7. The method of claim 6, in which the step of grouping the intermediate phrases into the second set of final phrases is carried out through finite state analysis.

8. The method of claim 1, in which the step of identifying logically significant conjunctions comprises the step of searching for predetermined phrase patterns from within the said partially analysed text passage.

9. The method of claim 1, further comprising, after the said step of identifying logically significant conjunctions in the partially analysed text passage, the steps of:
identifying a grammatically appropriate location for inserting of a second part of a two part conjunction within the passage of text to be analysed, when such second part of the said conjunction is not already present; and
automatically inserting at the identified location, an indicator into the reformatted passage of text when the text is displayed, the said indicator indicating that the said second part of the conjunction should be present there.

10. The method of claim 1, in which the passage of text is stored in electronic form on a digital computer, the method further comprising, prior to the step (a) of identifying words representing different parts of speech, the steps of:
receiving the passage of text to be analysed in electronic form; and
tokenising the received passage of text to identify separate sentences and paragraphs.

11. The method of claim 10, further comprising, after the step (c) of identifying logically significant conjunctions, the step of:
inserting formatting information into the passage of text in electronic form so that, when displayed, the logically significant conjunctions are distinguishable from the remaining text.

12. A computer readable medium upon which is recorded a software routine for carrying out the method of claim 1.
